(19) United States
(12) Patent Application Publication
(10) Pub. No.: US 2009/0012961 A1
(43) Pub. Date: Jan. 8, 2009

(54) SYSTEM AND METHOD FOR DEEPENING GROUP BONDS BY GRANTING ACCESS TO A DATA STRUCTURE

(75) Inventors: Ian Gerald Bramson, Middletown, MD (US); John Robert Nunnally, JR., Savannah, GA (US)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Balaya LLC

(21) Appl. No.: 12/163,811

(22) Filed: Jun. 27, 2008

Related U.S. Application Data
(60) Provisional application No. 60/937,736, filed on Jun. 29, 2007.
(60) Provisional application No. 60/962,507, filed on Jul. 30, 2007.

(51) Int. Cl. G06F 17/30

(52) U.S. Cl. 707/9; 707/10; 707/E17.032

(57) ABSTRACT

A method having the steps of granting, to a first client, access to a data structure; granting, to a second client, access to the data structure; transmitting, if the first client has caused a write operation on the data structure, a communication to the second client; and transmitting, if the second client has caused a write operation on the data structure, a communication to the first client. There is also provided a system, having a processor, that carries out the method. A method for strengthening group bonds, having the steps of: instantiating a data store that is dedicated to a predetermined group of users; receiving, into the data store, data generated by a first member of the group; providing an access to the data to a second member of the group; presenting the data to the second member of the group; receiving, from said second member, a communication into said data store; and wherein the communication is transmitted from the data store to the first member.

### CROSS-REFERENCE TO RELATED APPLICATIONS

The present application is claiming priority of U.S. Provisional Patent Application Ser. No. 60/937,736, filed on Jun. 29, 2007; and of U.S. Provisional Patent Application Ser. No. 60/962,507, filed on Jul. 30, 2007, the contents of both of which are herein incorporated by reference.

### BACKGROUND OF THE INVENTION

1. Field of the Invention

The present disclosure relates generally to a method and system for deepening group bonds on the Internet through the ability to pass user-generated information and data among a group in the form of a scrolling ticker. In particular, by assembling a robust and unique collection of collaborative tools online, such as a secure, private and exclusive system with which an established group can pass and view near real-time information, and display it on any number of electronic devices in an easy to comprehend scrolling form, the present disclosure allows group members to communicate and interact in ways that strengthen and deepen bonds. The present disclosure focuses on the needs of a group rather than an individual, and thus allows a group to plan, create, organize, play, shop, and reminisce together in ways that strengthen and deepen bonds.

2. Description of the Related Art

A communication method commonly known as a “ticker” routinely pushes information from a central point to a number of receivers and displays the information as a sequence of scrolling text. There are many well-known tickers such as those operated by DOW Jones, ESPN, and Bloomberg. Each pushes some type of information out to subscribers of the data. As a result of this one-to-many push approach, the roles of the sender and receive are well-defined: a sender sends; a receiver receives. The present disclosure has a different approach that treats all members of a self-selected group as both senders and receivers of important, group-generated information. By focusing the ability of a ticker to present information in an easily comprehensible format upon the inherent need for a group to communicate clearly among its membership, the present disclosure applies a proven tool in a new manner. This group focused approach, combined with a specific technical means of providing near real-time connectivity among members of the group and presenting the ticker information on an array of electronic devices, differentiates the present disclosure from the prior art.

Tickers currently available to the public are not focused on what a group needs to facilitate inter-group communication and by extension what the group needs to deepen their bonds with other members. Current tickers provide a subscriber with access to data that can be personalized and screened by specified areas of interest as a way of improving personal consumption and then present the information on a computer screen.

There is no trusted, exclusive space where established, diverse groups can collaborate and interact across a wide range of topics, interests and functions in order to deepen their bonds by creating a shared history and being an active, integrated part of each others lives.

Most Internet sites, even those labeled as family-focused, place an individual at the center of the online value chain and, as a result, deliver specific capabilities to a single individual. Doing so fails to provide tools a group can collectively use to meet the needs of an established and trusted network.

The present disclosure's emphasis is on the group, not the individual, a specific application or a particular affinity. By providing unique software applications that deliver collaborative communication and content development, the present disclosure helps groups experience closeness and develop a shared sense of history that transcends the mere exchanging of information provided by traditional online services. Relying on the exclusivity and trust resident in an established network, the present disclosure allows members to accomplish the myriad of “need to do” tasks—communicating, planning, creating, sharing, and playing—in a secure and productive environment. As a group's affinities rise and fall in priority, the present disclosure adjusts and adapts its offerings and structure to provide the user with the tools, topics, and links that are most needed now. The present disclosure provides group connectivity across a host of devices from computers to mobile phones to simple, receive-only terminals allowing an online group the ability to connect and experience each other regardless of physical location or level of computer/electronic savvy.

The present disclosure has advantageously developed a ticker that is designed specifically for use by an established group via an array of electronic devices. Members of the group do not subscribe to various outside data sources that may or may not be of interest to the other members of the group. Rather, group members are able to uniquely generate their own content, making it as robust as desired, and provide it to the known, exclusive and secure network to which they belong. The data provided through the ticker, by virtue of it being shared among an established group known to each other, is inherently relevant to the group and of potential personal interest. Making the information available on an array of electronic devices extends the connectivity of the group and provides a near real-time flow of ideas and events. This enhanced personal interaction with other members of the exclusive network helps deepen the bonds of the members.

That is, the present disclosure differs from conventional tickers in that it is a member-based apparatus that is message focused with all members being able to create user-generated content that can be sent to all other members.

The present disclosure is different from conventional tickers in that it allows an exchange of information only among a known membership wherein the group establishes an exclusive network and places user-generated content on the ticker service for the express purpose of informing other members of the exclusive network.

The present disclosure is uniquely adapted for use related to computers and mobile devices, such as cellular telephones.

The present disclosure, while operable in a window-based system is also operable in a non-window based system. Additionally, the data presented by the present disclosure is not sourced from multiple, broadcast networks but rather from a single network specifically attributable to the development and sharing of user-generated content. The present disclosure is focused on providing a ticker device as a communicative tool with which members of a secure, exclusive group can generate and share content.

The present disclosure also provides many additional advantages, which shall become apparent as described below.

### SUMMARY OF THE INVENTION

There is provided a method comprising granting, to a first client, access to a data structure; granting, to a second client, access to the data structure; transmitting, if the first client has caused a write operation on the data structure, a communication to the second client; and transmitting, if the second client has caused a write operation on the data structure, a communication to the first client.

There is provided a system comprising: a first client device; a second client device; a processor; a memory; wherein: the processor is in communication with the memory; the first client has a user interface that is a ticker; the first client device is in communication with the processor via a communication network; the processor instantiates a data store in the memory comprising a first data structure and a second data structure.

A system and method of deepening group bonds by sharing information and data via a closed network ticker apparatus which: i) provides user-generated content pertinent to the user's specific group; ii) offers “members-only” access such that a particular group or family's ticker is for the invited/enrolled members only, providing tailored information, not broadcast information; iii) delivers ubiquitous access via multiple electronic, communications-enabled devices; iv) offers prioritized information via self-selected priority triggers; and v) providing additional information by way of links, attachments, or embedded data to a ticker postings to strengthen the sharing experience.

The present disclosure also provides the steps of: (i) delivering an exclusive and trusted operating location to the group; (ii) providing a comprehensive and interconnected menu of collaborative tools thus eliminating the need to travel between multiple sites or access multiple accounts; (iii) delivering ubiquitous access via multiple electronic devices; (iv) allowing connectivity matched to the skill level of each member of the group (e.g., a simple, receive-only terminal in grandmother's assisted living unit allows a near constant updating of photos and other media); and (v) creating a centralized and safe location where groups can store, share, and collaboratively develop a broad range of important family items including photos, audio and video files, cherished recipes and other key documents and files.

The present disclosure provides web-based capabilities and uniquely interactive tools for groups that already have close-knit bonds (e.g., families, college friends, Homeowner Associations). These groups can be diverse in many ways, including geographical location, age and ideology. The group's web material will only be accessible to those in the group and invited guests. This will create a trusted environment where the group can freely interact.

Another embodiment facilitates people working together to create shared content (e.g., shared recipe books, joint newsletters, multi-media family timelines) and interact via a myriad of activities (e.g., planning, creating, sharing, playing, shopping) that reflect the nature and behavior of trusted groups. Although the present disclosure focuses on groups, individual members will have full use of the site's tools and functions and will be able to create a personalized portal through which they will access the group tools and data.

Since the present disclosure focuses on groups first—instead of an affinity, theme or particular interest—it offers a wide range of activities, functions and applications to the group (e.g., from creating a group photo album to online shopping together). The diversity of the tools and functions will allow the group to remain connected and productive as they change their interests and choose to focus on different activities. Also, subsections of the groups can focus on different areas. As a group's needs change, the disclosure remains relevant and useful because its focus is on the group not on a single application or capability.

Group members are a much larger part of each others lives because the present disclosure goes beyond the current art of providing for the exchange of information (e.g., sending emails, posting and reading blogs) and enables people to experience close interaction through collaboration and sharing of activities.

The shared experiences of the present disclosure enable a group to generate and sustain a common history. Every activity, interaction, or piece of new content they develop together creates a bonding activity in the form of a shared history—“we did that.”

Further objects, features and advantages of the present disclosure will be understood by reference to the following drawings and detailed description.

### BRIEF DESCRIPTION OF THE DRAWINGS

The present disclosure will be more fully understood with reference to the several drawing figures, in which:

FIG. 1 is a block diagram of a communications system;

FIG. 2 is a block diagram of a system having a processor;

FIG. 3 is a block diagram of a system of the present disclosure;

FIG. 4 is a block diagram depicting the basic hardware, software, and user interaction of the present disclosure;

FIG. 5 is a block diagram depicting the general utilization of the present disclosure and its key elements;

FIG. 6 is a block diagram of an embodiment of a ticker graphical user interface;

FIG. 7 is a schematic diagram of steps for generating an initial group site;

FIG. 8 is a schematic diagram of user steps related to the creation of user content and submission of same into a group network;

FIG. 9 is a schematic diagram depicting an experiential data linkage according to the present disclosure;

FIG. 10 is a schematic diagram depicting the delivering of a genuine collaborative experience according to the present disclosure;

FIG. 11 is a schematic diagram depicting the creation of a shared history according to the present disclosure;

FIG. 12 is a schematic diagram depicting a system for managing a comprehensive and dynamic family calendar according to the present disclosure;

FIG. 13 is a schematic diagram depicting a system for communicating together according to the present disclosure;

FIG. 14 is a schematic diagram depicting the basic hardware, software, and user interaction of the disclosure;

FIG. 15 identifies the nature of the disclosure's integrated advantage;

FIG. 16 is a schematic diagram depicting the general utilization of the disclosure and its key elements;

FIG. 17 is a schematic diagram of a conventional “Me” Internet approach;

FIG. 18 is a schematic diagram of a communal site for deepening bonds one experience at a time according to the present disclosure;

FIG. 19 is a schematic screen shot of a personalized portal according to the present disclosure;

FIG. 20 is a schematic diagram of the method for accessing the tools and features presented through the portal;

FIG. 21 is a schematic diagram of user steps for generating an initial group site;

FIG. 22 is a schematic diagram of user steps related to organizing a group event (Planning and Organizing Together);

FIG. 23 is a schematic diagram of user steps related to the creation of shared content (Creating Together); and

FIG. 24 is a schematic diagram of user steps related to holding an online game within the group (Playing Together).

### DETAILED DESCRIPTION OF THE PREFERRED EMBODIMENT

This method and system allows people to be a greater part of each others' lives by providing them with an easy to use, easy to comprehend communication tool that facilitates contact and sharing among a network of users. It focuses on the unique needs and preferences of the group by providing an exclusive, secure method for the sharing of key data and information. The use of the ticker as a communication tool shared by only invited members of a group allows members to be much more relaxed and honest in their interactions.

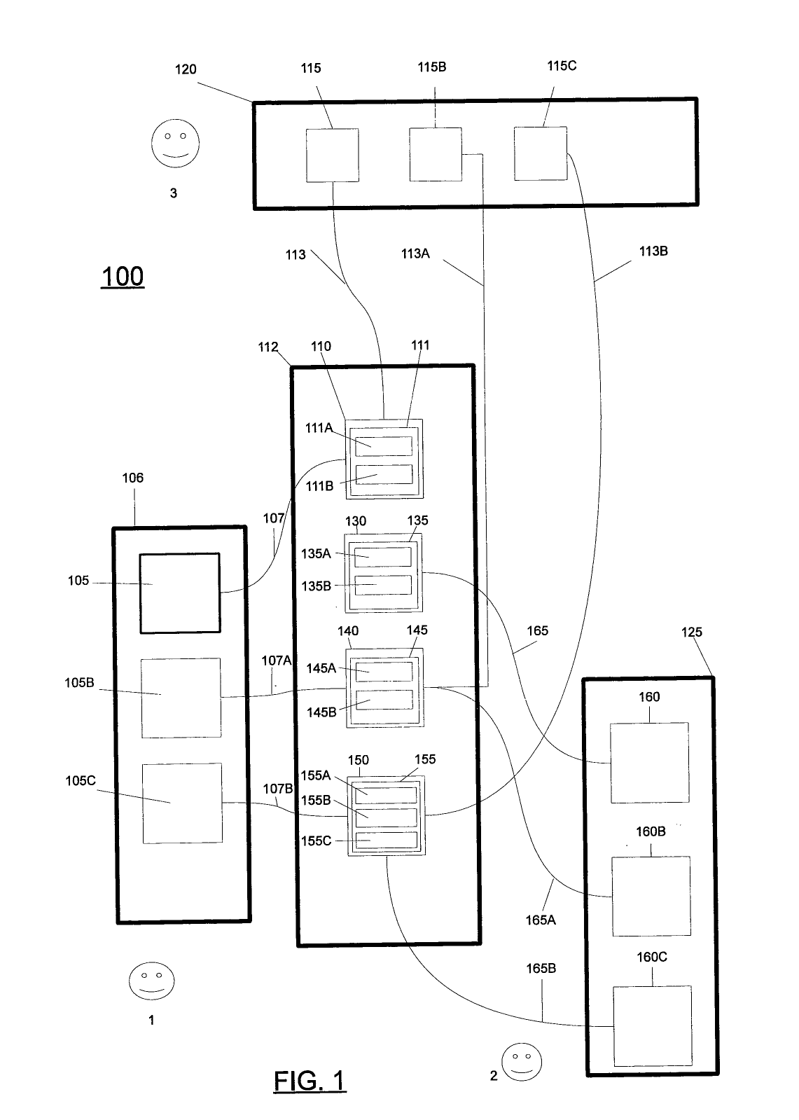

FIG. 1 is a communications system 100. Communications system 100 includes a central database 112, client devices 106, 120, and 125, and is used by users, e.g., users 1-3.

Central database 112 is in communication with client devices 106, 120, and 125 via communication links, e.g. communication link 107. Communication link 107 could be implemented over a packet-switched network, a circuit-switched network, or a combination thereof.

Central database 112 contains private, sectioned parts, e.g., areas 110, 130, 140, and 150. Although depicted in FIG. 1 as a single entity, central database 112 may be implemented as several entities.

Client device 106 is connected and dedicated to central database 112 (e.g., via communication link 107) such that user 1 can post content 111A from client device 106 to central database 112, and another user 3 with a similar client device 120, also connected and dedicated to central database 112, can view central database 112 to read content 111A. Client devices 106 and 120 and content 111 are organized by private, established and persistent communication channels, e.g., message channel A (not shown) connecting user devices 106 and 120 to a private, sectioned part, e.g., area 110, of central database 112. This provides several novel capabilities. Client devices, e.g., client device 106, support a number of clients such as client 105, 105B, 105C. In one embodiment, client 105 is implemented as a software module, but could in general be implemented in any of software, hardware, or firmware.

Content 111A, authored by user 1, remains editable and deletable by user 1 even after user 3's client device 120 has polled central database 112 and received content 111A. User 3 cannot edit content 111A. Central database 112 captures content 111 from all users for a particular private channel, e.g., message channel A, so that, when a new user, e.g., user 2, joins message channel A, user 2 receives instant access to content 111. Also, all users in a communication channel have a consistent and common history of their conversations, since they all have access to content 111.

Message channel A includes client 105, communication link 107, area 110, communication link 113, client 115, and content 111.

Message channel B includes client 105B, communication link 107A, area 130, communication link 165, content 135, and client 160.

Message channel C includes area 140, client 115B, communication link 113A, communication link 165A, client 160B, and content 140.

Message channel D includes area 150, client 105C, client 115C, client 160C, content 150, communication link 107B, communication link 165B, and communication link 113B.

User 1, via client device 106, dynamically views content 111, 135, 155 from message channels A, B, and D, either by selecting to view particular content 111, 135, or 155 or by viewing content 111, 135, and 155 from all channels at once.

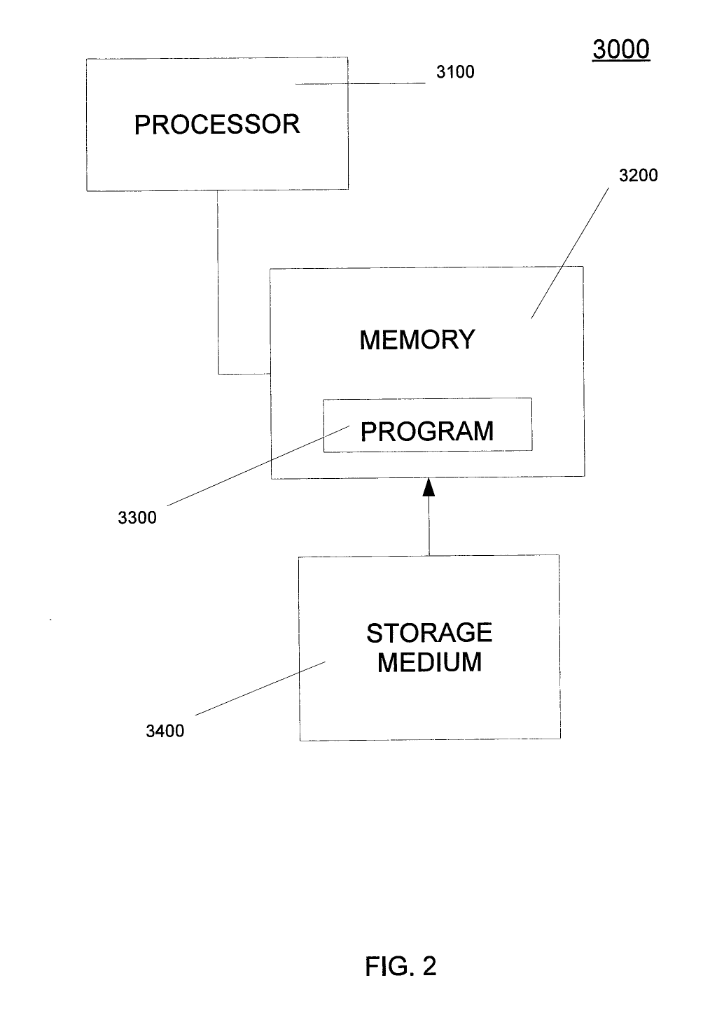

FIG. 2 is a block diagram of a system 3000 for executing the methods described herein, and thus serves as an exemplary embodiment of communications system 100. System 3000 includes a processor 3100, a memory 3200, a program 3300, and a storage medium 3400. System 3000 may be implemented on a general purpose microcomputer. Although system 3000 is represented herein as a standalone system, it is not limited to such, but instead can be coupled to other computer systems (not shown) via a network (not shown).

Memory 3200 is a memory that stores data and instructions that control processor 3100. An implementation of memory 3200 would include a random access memory (RAM), a non-volatile data store, and a ROM. One of the components of memory 3200 is a software program 3300.

Program 3300 includes instructions for controlling processor 3100 to execute the processes described herein. Program 3300 may be implemented as a single module or as a plurality of modules that operate in cooperation with one another. The term “module” is used herein to denote a functional operation that may be embodied either as a stand-alone component or as an integrated configuration of a plurality of subordinate components.

Storage medium 3400 is any suitable storage medium having encoded thereon a set of instructions that, when loaded into a memory such as memory 3200, instantiate program 3300.

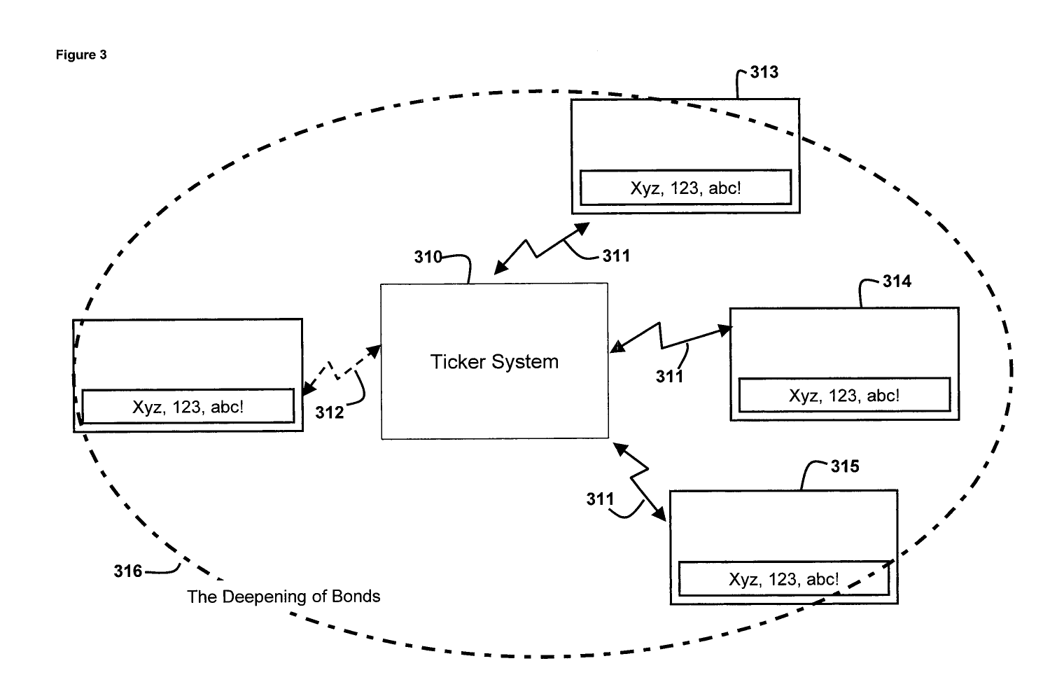

FIG. 3 is a block diagram of a ticker system 310 for providing near real-time, push-to-device user-generated information 311 that means group members do not have to log into their email or visit a web site to find out about Tommy's home run in today's t-ball game. Instead, Billy's mom uploads the information/data 312 to the ticker system 310, where Aunt Mary receives the information on her desktop 313 when she turns on her computer. Grandfather sees the information on his cell phone 314 at the golf course, and Great-grandmother gets the information on her simplified user screen 315 from her room at the assisted living center. In this way, the system 310 allows the established group to create, share and interact with other members of the group despite location or particular type of data receiver. Each member of the network experiences the benefit of the communication and the deepening of bonds 316 to others in the group. In one embodiment of the present disclosure, the members can reply back to the announcement adding even deeper connections and bonding.

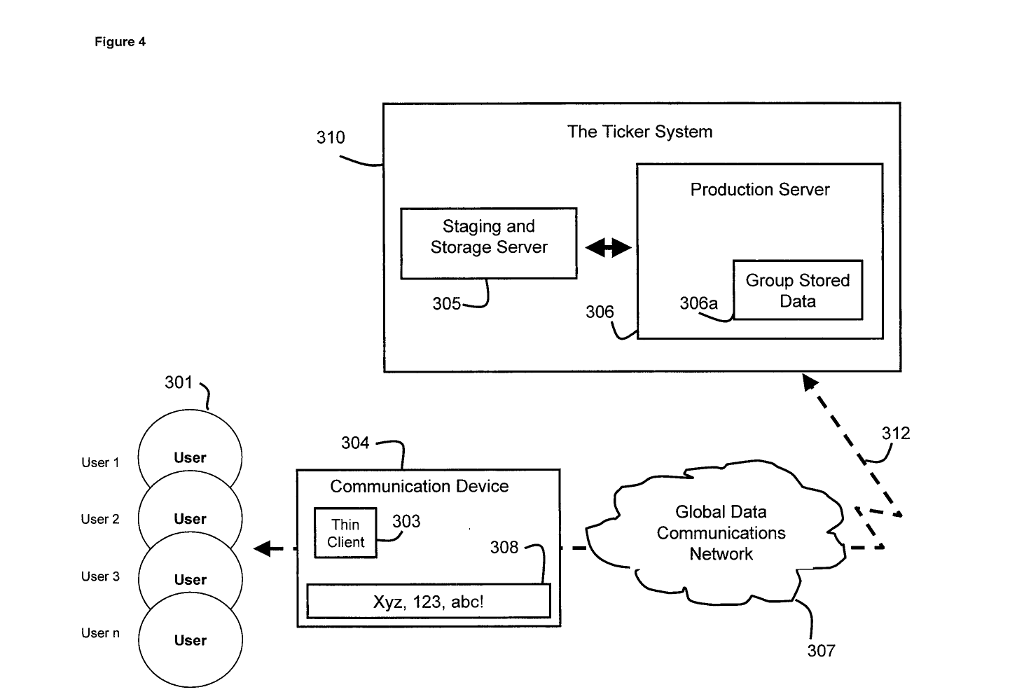

FIG. 4 describes the basic hardware, software, and user interaction related to the disclosure. The ticker system 310 runs flash-based software and comprises a staging and storage server 305 for the development and testing of new system capabilities and a production server 306 that permits registered users 1 (here noted as any number of users forming a group from user 1 to user n) to upload, store, and transmit information/data 312, as stored data 306a, by way of a communication device(s) 304 (e.g., a computer, cellular phone, or PDA) connected to a global data communication network 307 (e.g.; the internet or a mobile telephone system by way of example). Each user 1 may have any number of communication devices 304; however, for simplicity of this figure and explanation, a single communication device 304 is portrayed. A thin client application 303, provided to users 1 through the production server 6 and stored within a user's communication device(s) 304 provides the means for the communication device 304 to generate, transmit, query, download, and display information for the ticker display 308. Users 1 communicate bi-directionally through the global data communication network 307 to the production server 306 to upload, store, and transmit information/data 312 for presentation on the group's shared ticker and/or to query and download new data other users may have submitted. Individual user preferences and actions, as well as group generated content, is stored within the production server 6 on a group storage area 6a and made available to a user device 304 when requested by the thin client 303. In one embodiment, the ticker system 310 serves as a hub for the group communication network receiving and transmitting the user-generated inputs from and to the users 1. In other embodiments, the ticker system 310 may serve only as a peer within the group network to enable the network to remain dynamic and accessible, thus allowing users 1 to connect or disconnect from the network without fear of losing or being unable to add, access, or transmit to other peers in the network. The thin client application 303 allows a user 1 to personalize their ticker display 308 and to control how and at what intervals (e.g., every second, every 30 seconds, etc.) data is sourced and displayed. A number of message and data transport Languages, mechanisms, and protocols may be used to affect communication with and transfer of data between the user 1 and the production server 6 including but not limited to, Flash, P2P, TCP/IP, RSS, ICQ, MMS and SMS. While a single staging and a single production server are depicted, as is a single global data communication network, those skilled in the art recognize that a number of servers, connected or independent, co-located or geographically separated, as well as a number of connected or independent global data communication networks may be used to create and operate the system 310.

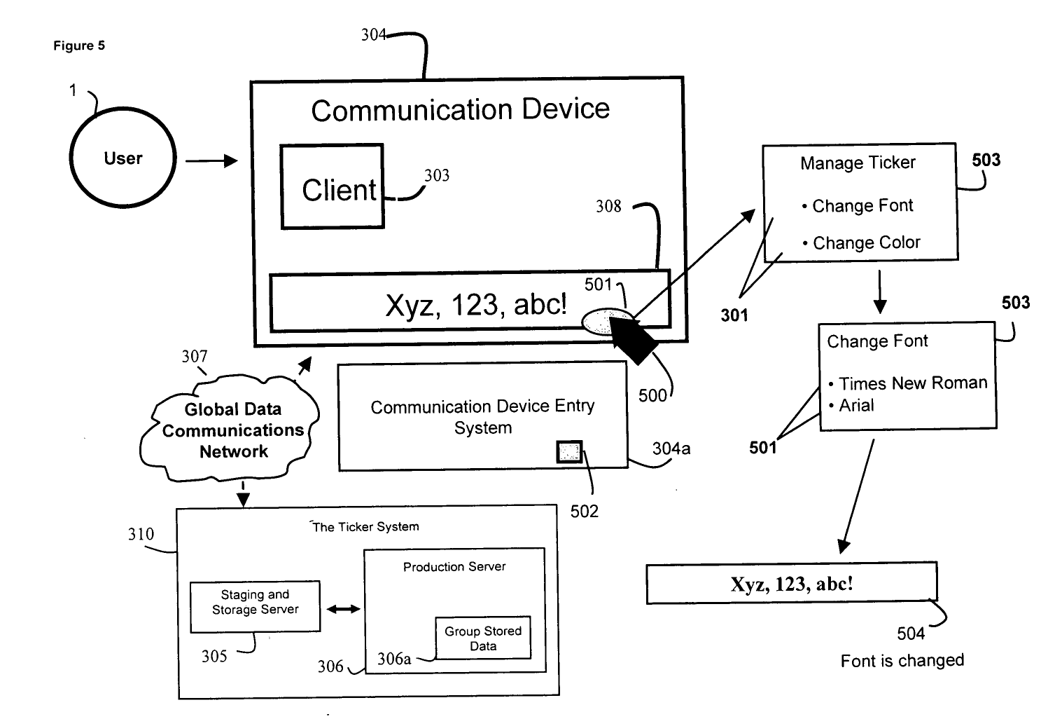

FIG. 5 presents how a user 1 generally utilizes the disclosure. A user 1 accesses the ticker's supporting thin client application 303, and by extension the ticker system 310, through interaction with the ticker display 308. In one embodiment, a user 1 navigates a computer cursor 500 or similar interest notating apparatus to a link 501 on or within the ticker display 308. Once the cursor 500 is in contact with the link 501, the user 1 activates the link 501 by pushing a button or key 502 on the communication device's data entry system 304a. Activating a link 501 presents the user 1 with an interactive access window 503 or similar area of interest apparatus that provides the user 1 with more links 501 to choices and options relative to the specific action or activity desired. Each activation of a link 501, further defines the user's options relative to the specific action or activity desired and allows the user 1 to perform an action or attain information the user 1 needs (i.e., selecting “Manage the Ticker” presents the user 1 with an option to select “Adjust Font” or “Adjust Color”. Selection of “Adjust Font” presents the user with an option to select “Times New Roman” or “Arial”. Selecting “Times New Roman” presents the scrolling ticker data in the Time New Roman font). Having selected the specific option or combination of options available through the links 501, the user 1 is able to take the desired action 504 in accordance with its attendant user or operating protocol. The thin client application 303 notes the desired action and, as required, retains knowledge of the action and/or communicates it to the ticker system 10 for action. The ticker system 310 may, when required by the action protocol, store and/or transmit the action to other members of the group (i.e., relay a data/information input for presentation on the ticker displays 308 of all group members). Utilizing this general method of personalizing the choices, actions, and operation of the ticker, the user 1 can manage issues related to ticker usage such as sending a message to all or some of the members of the group (i.e., a user could by-pass a member to tell other members about a surprise party for the person by-passed), lengthen or shorten the time messages are held for archiving by the ticker system 310, or place emphasis on a particular message (i.e., a message deemed an emergency message can be given greater priority by the ticker system 310 and displayed more often on the ticker or in an attention grabbing font or color).

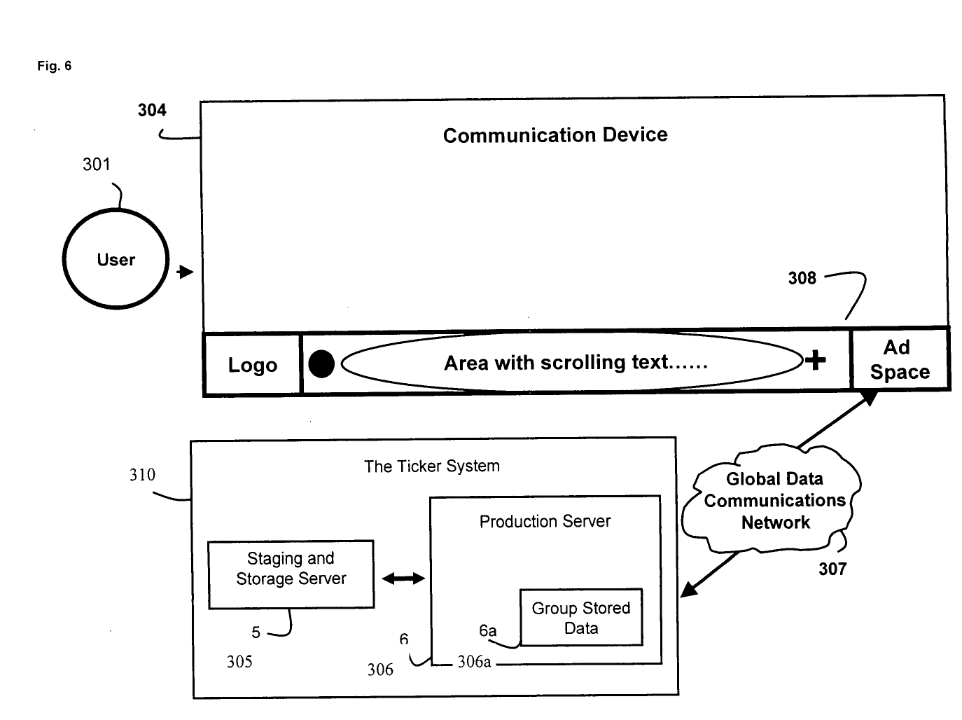

FIG. 6 presents a mockup of an embodiment of the user interface of the ticker. In this mockup, the user interface is the ticker display 308 wherein the user 301 is able to see data/information created by other members of the established and secure group network as it scrolls across a communication device 303. The communication device 303 may be any of a number of apparatus including, but not limited to, computer screens, mobile phone screens, personal digital assistant (PDA) screens, or other, simple to use systems designed to receive and transmit to and from the group through a global communication network 307. In one embodiment, the ticker display 308 resides on the top, bottom, or side of a computer screen without being covered up or otherwise unseen and rendered inaccessible by applications or computer programs also being displayed on the same computer screen. In another embodiment, the ticker display 308 may be unseen until a notification (e.g., an aural tone such as a ring or a vibrating action) prompts the user to take an action (e.g., hit a key or press a button) that places the ticker display 308 on a screen. With the ticker display 308 in view, a user 1 is able to access the actions and activities attendant to the ticker and use the ticker system 310 to participate in communication with the exclusive group.

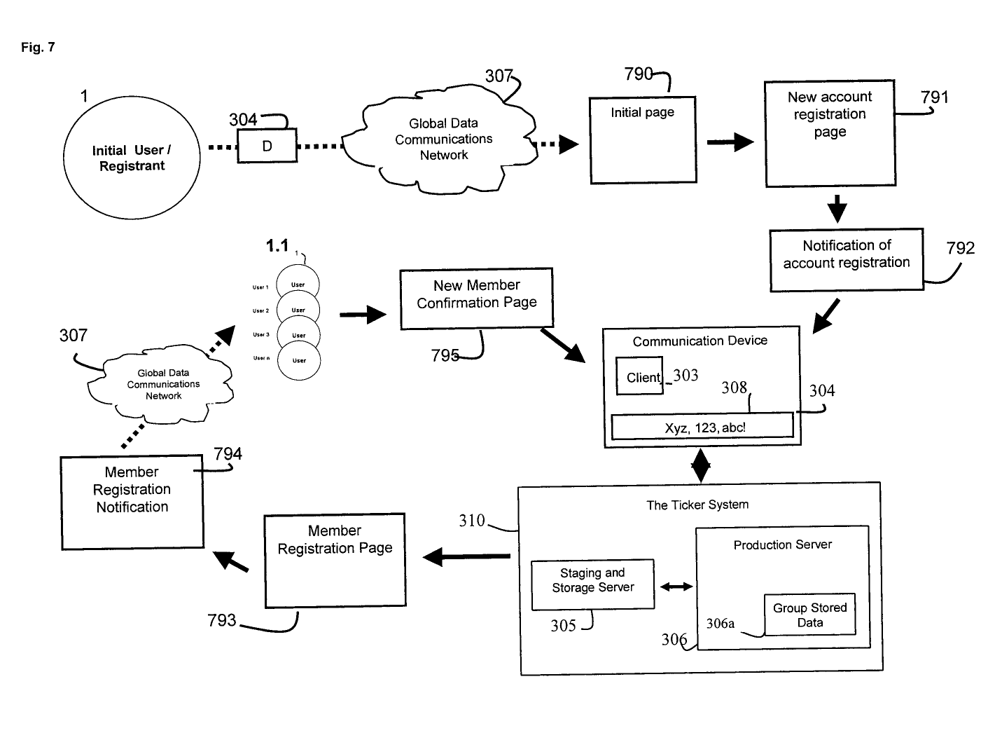

FIG. 7 is a schematic depicting the initial set-up of a group's ticker account. A user/registrant 1 utilizes a communication device 304 and a global data communication network 307 to connect to the disclosure's production-server hosted initial page 790. The user navigates to a new account registration page 791, and, upon satisfactory completion, the group ticker account is created and an account notification is provided 792. With an account notification 792, the user/registrant 1 is able to download the thin client application 303 from the production server 306, begin personalizing and using a ticker display 308, and register additional group members via a member registration page 793. When a new user/member is added to the group via the member registration page 793, a notification of registration 794 is sent via the global data communication network 307 to the new user/member 1.1 directing them to a new member confirmation page 795. The new user/member 1.1 successfully completes the confirmation process and is allowed to download the ticker's client application 303 and begin personalizing and using a ticker display 308. With a ticker display 308, a new user/member 1.1 can communicate via the ticker system 310 to any and all members that also belong to that group. The assignment of membership for the group, and by extension, the ability to personalize and use a ticker display 308 and participate in the group's communications, is vested in the initial user/registrant 1. Once joined as a member of the group, any user 1-1.1 can participate in the group communications through their personalized ticker display 308 (for this figure and simplicity of explanation, only one communication device 304 with client application 303 and ticker display 308 is shown; however, each user may have any number of this items). Because users may belong to more than one established, secure and exclusive group, they may have access to more than one ticker display. If a user belongs to more than one group, a user can choose to have the ticker display 308 scroll the data/information of all the groups on a single display in which case the ticker system will identify the data of the separate groups so each can be properly recognized and attributed. In one embodiment, this identification of different group data may be in the form of presenting it on the ticker display 308 in a different font, different color, or separated by a distinguishing graphic.

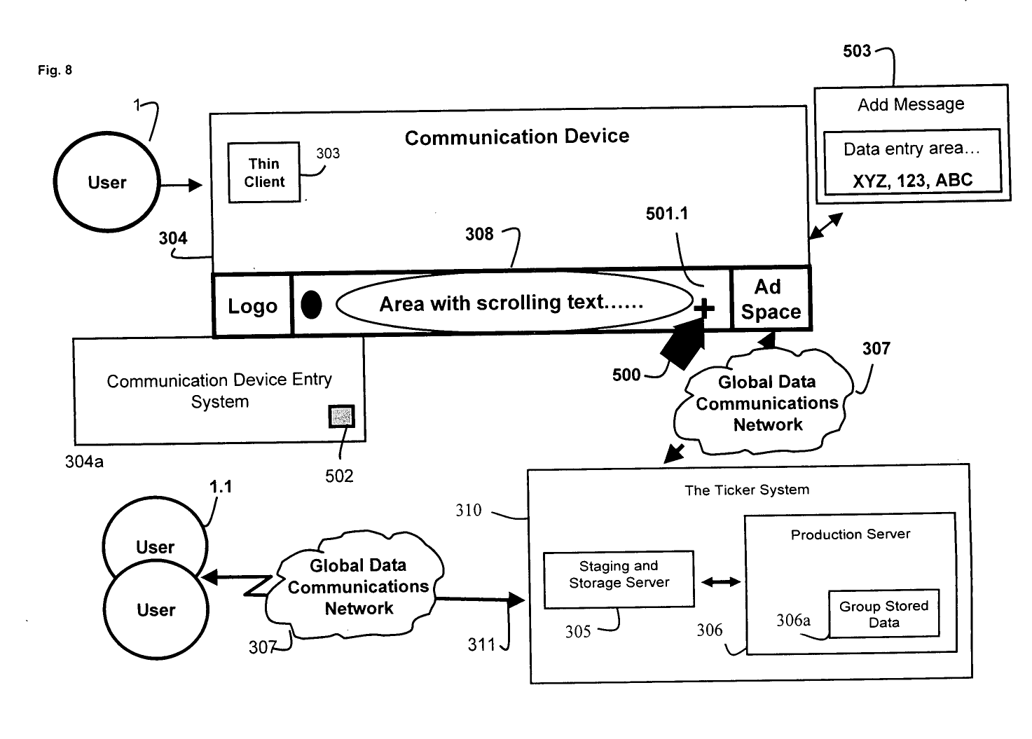

FIG. 8 describes how users 1 within a group can create and share ticker content with the group. By making the ticker display 308 available on a communication device 304, a user 1 is able to both manage the display of ticker information on their device (e.g., the speed, font type, text color, rate at which new data is queried and presented) and contribute to the data/information that is displayed on the tickers of each member. In one embodiment, to contribute user generated content to the ticker, a user 1 navigates a computer cursor 500 or similar interest notating apparatus to a link for adding a message 501.1 on or within the ticker display 308. Once the cursor 500 is in contact with the adding message link 501.1, the user 1 activates the link by pushing a button or key 502 on the communication device's data entry system 304a. Activating the link 501.1 presents the user 1 with an interactive access window 503 or similar area of interest apparatus that provides the user 1 with the ability to enter the data/information they would like to have presented on the group ticker. When ready, the user 1 signals the data/information is ready for transmission to the ticker. In one embodiment, the client application 303 initiates connection with the ticker system 310 through connectivity with a global data communication network 307 and provides the data/information for both storage in the group's stored data area 306a area and for transmission via the same or a different global data network 307 to the other members of the group 1.1. This new data/information is transmitted in near real-time 311 to the other members and is displayed in accordance with the particular protocols of their individual communication devices. By the collaborative efforts and experience of sharing in the creation of the timeline help deepen the bonds of the participants.

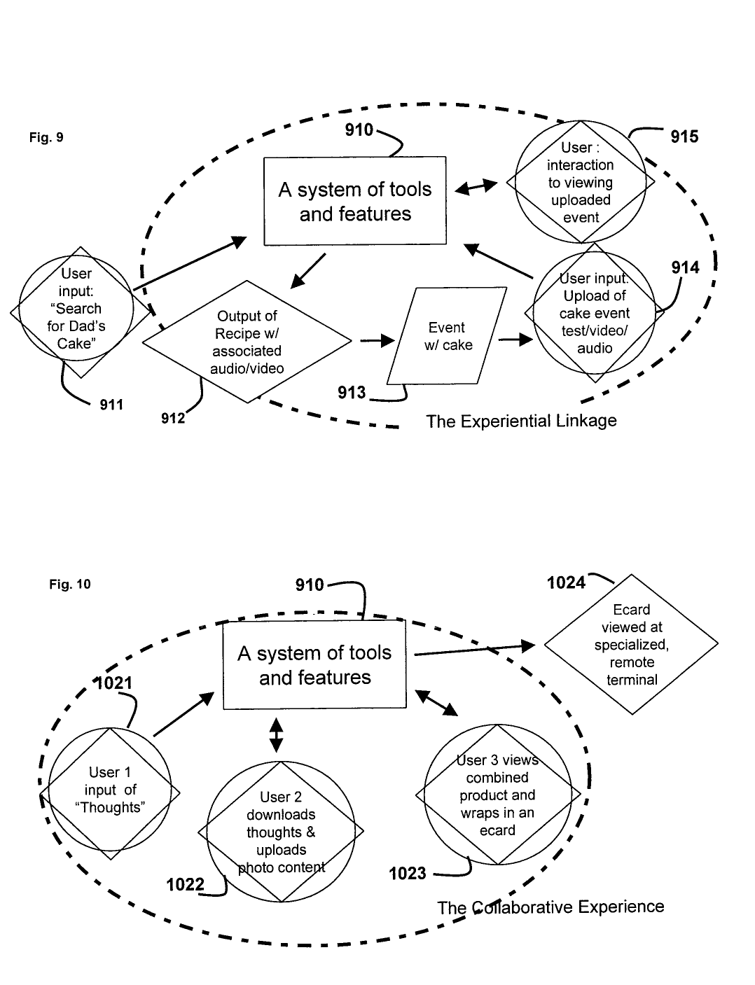

FIG. 9 describes a system 910 for providing experiential data linkage, i.e., users do not just see a photo, hear an audio file, or look up a cherished recipe someone uploaded to your group storage area; rather, you search for “dad's cake” 911 and gain access to a whole “multi-media package” 912 of hearing mom talk about the cake she always makes for dad's birthday while you see a picture of him blowing out the candles, and being presented with the recipe. You make the cake for your son's birthday and hold your own event 913. You upload the whole “audio, video, and text experience” of your event 914 to the “family timeline album” where your parents see and experience the tradition being passed down 915.

FIG. 10 describes a system 910 for delivering a genuine collaborative experience, i.e., users do not write a blog, rather, you jot down your thoughts on the “group note pad” 1021 and your brother, on the road in California, adds in some photos 1022. Your dad wraps it into an e-card 1023 and forwards to your grandmother who, though she is not computer savvy, can view it 1024 with “simply a touch” of a button on a “connection terminal” screen in her living room.

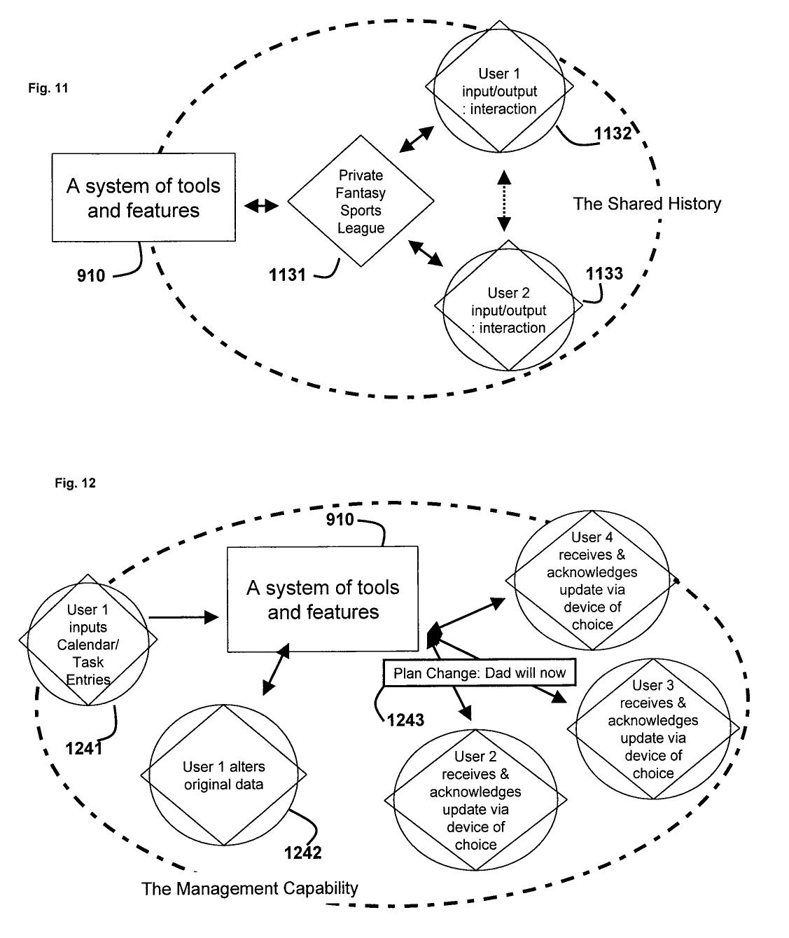

FIG. 11 describes a system 910 for creating a shared history, i.e., users do not exchange polite emails with a sister's new guy, rather, you invite him to join the group's “fantasy football league” 1131 and, as you 1132 and he 1133 interact with the game and your team beats the stuffing out of his, you get to develop a shared history of the ups and downs—and the accompanying smack talk—of a whole season.

FIG. 12 describes a system 910 for managing a comprehensive and dynamic family calendar, i.e., users do not stick a post-it note in a spouse's wallet hoping he remembers to pick up your daughter. Rather, a user 1241 enters data into the shared calendar which is broadcast via a “group ticker” on a recurring basis to each of the members—to a mobile device, work or home computer—so the “who has what” part of the family dynamic is parsed out. When your business meeting looks like it is going to run late, you update the input 1242 in real time to change the game plan. The update is broadcast immediately via the “group ticker” to group members 1243 resulting in a successful re-parsing of the tasks.

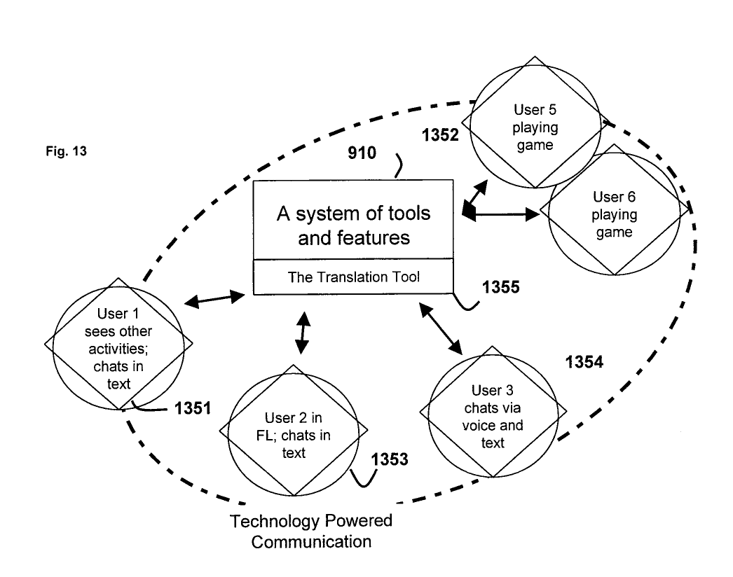

FIG. 13 describes a system 910 for communicating together with the power of today's technology, i.e., users do not just use an instant messaging system or chat application when a sibling is online; rather, a user 1351 logs onto the system 910 of the present disclosure and notes that dad and a brother are holding their normal Thursday card game 1352 and that mom and sister are currently chatting. The user also notes sister's “location marker” shows she is not at home, but in Florida 1353; the user quickly join the conversation to find out what is up. Of course, since the user and the sister are great on the keyboard and love using text shortcuts like “LoL” questions and answers flow fast and furious. Mom is not left out though 1354; using her preference of “text to voice” conversion—she hates to type—and the “shortcut translation tool” 1355 imbedded in the system 910 she catches everything.

The disclosure brings together tools and features and creates others, melding them all in a seamless and interrelated manner and presenting them in a single location. By incorporating the tools and features is this way, the disclosure allows a group to communicate, research, act and warehouse data efficiently. The accomplishment of the tasks, in this collaborative manner, strengthens and deepens the bonds of the participants.

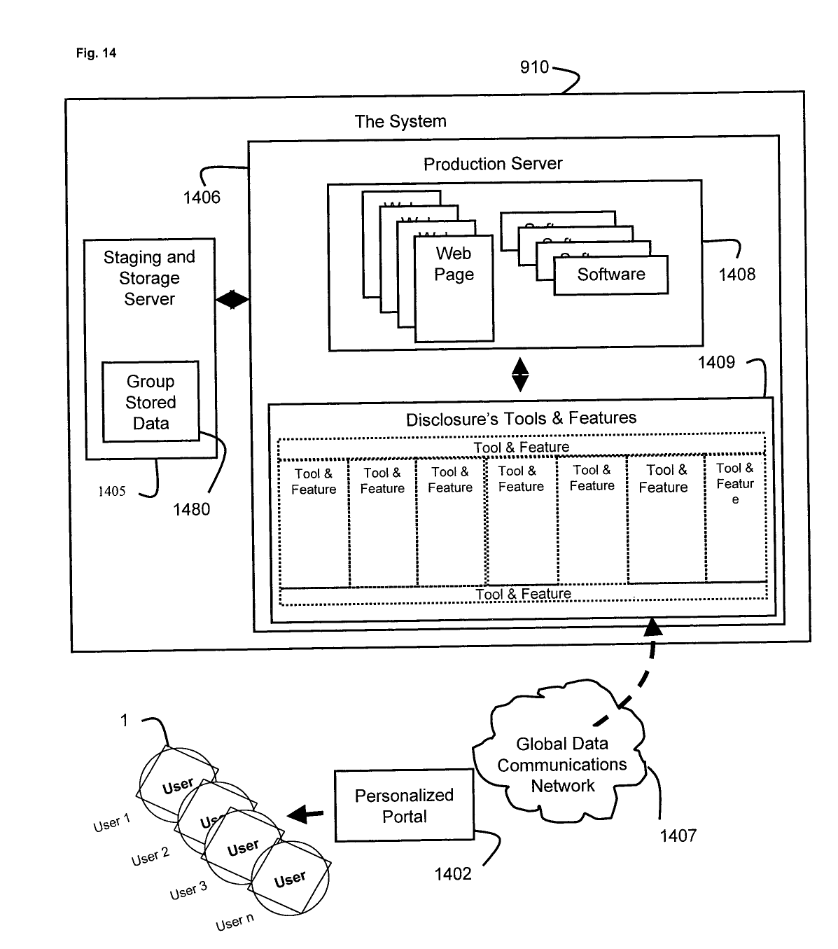

FIG. 14 describes the basic hardware, software, and user interaction related to the disclosure. The system 910 includes a staging and storage server 1405 for the development and testing of new web pages and software and a production server 1406 that hosts a plurality of web pages and software 1408 that deliver specific tools and features 1409 to registered users 1 (user 1 through user n) through a global data communication network 1407 (e.g., the internet or a mobile telephone system). Within the staging and storage server 1405 is the storage area for group data 1480. Users 1 communicate bi-directionally through the global data communication network 1407 to the production server 1406. A number of message and data transport mechanisms and protocols may be used to affect communication with and transfer of data between the user and the production server including, but not limited to, P2P, TCP/IP, RSS, ICQ, and SMS. A personalized portal 1402 allows users to interface with the plurality of web pages and software 1408 thus enabling a closed network to perform collaborative and bonding tasks. While a single staging and a single production server are depicted, as is a single global data communication network, those skilled in the art recognize that a number of servers, connected or independent, co-located or geographically separated, as well as a number of connected or independent global data communication networks may be used to create and operate the system 910.

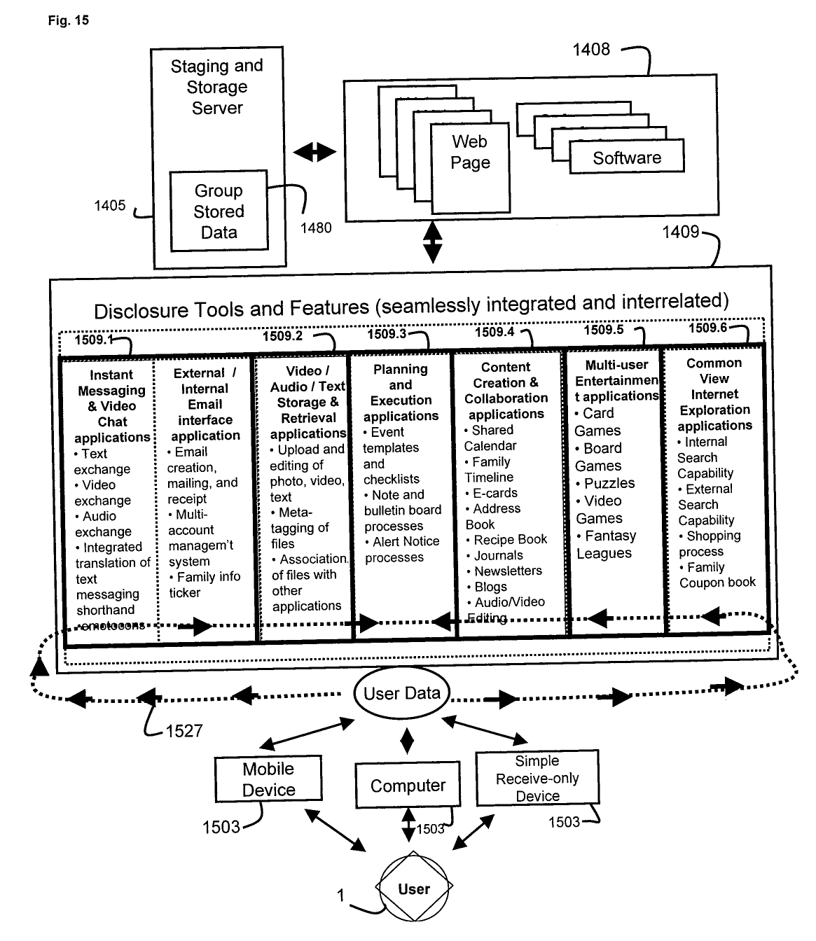

FIG. 15 identifies the nature of the disclosure's integrated advantage. The disclosure presents a holistic approach that improves collaboration and efficiency. Arranged by traditional group activities—communicating, planning, creating, sharing, and playing together—the plurality of web pages and software 1408 deliver specific tools and features 1409 that are accessible by multiple electronic devices 1503 (e.g., mobile phones, PDAs, computers, and simple receive-only apparatus), thereby greatly increasing the capability of group members to participate. The tools and features 1409 are connected to and provide bi-directional access to the group's stored data 1480 located in the staging and storage server 1405. Within the tools and features are applications that allow users to communicate via voice or text 1509.1 (e.g., Instant Messaging and Video Chat, input-output translators, email construction and management), store/use/retrieve files 1509.2 (e.g., upload and meta-tag audio, video, photographic, and text files), develop and execute plans 1509.3 (e.g., download checklists and ideas, create notes and task reminders), collaboratively create new content 1509.4 (e.g., build a family timeline, a shared calendar, community address book, multi-media recipe file), participate in group games 1509.5 (e.g., play cards, board games), and explore the web 1509.6 (e.g., surf and shop with a common screen presentation). The seamless integration of the tools and features 1409 allows users 1 to flow data and information among multiple applications 1527; presenting the ability to enter data once and have it available in a number of related but disparate applications (i.e., a photograph uploaded could flow automatically via meta-tagging to an album, the address book, and the family timeline). This array and arrangement of tools and features 1409 presents an efficient means for the accomplishment of group activities.

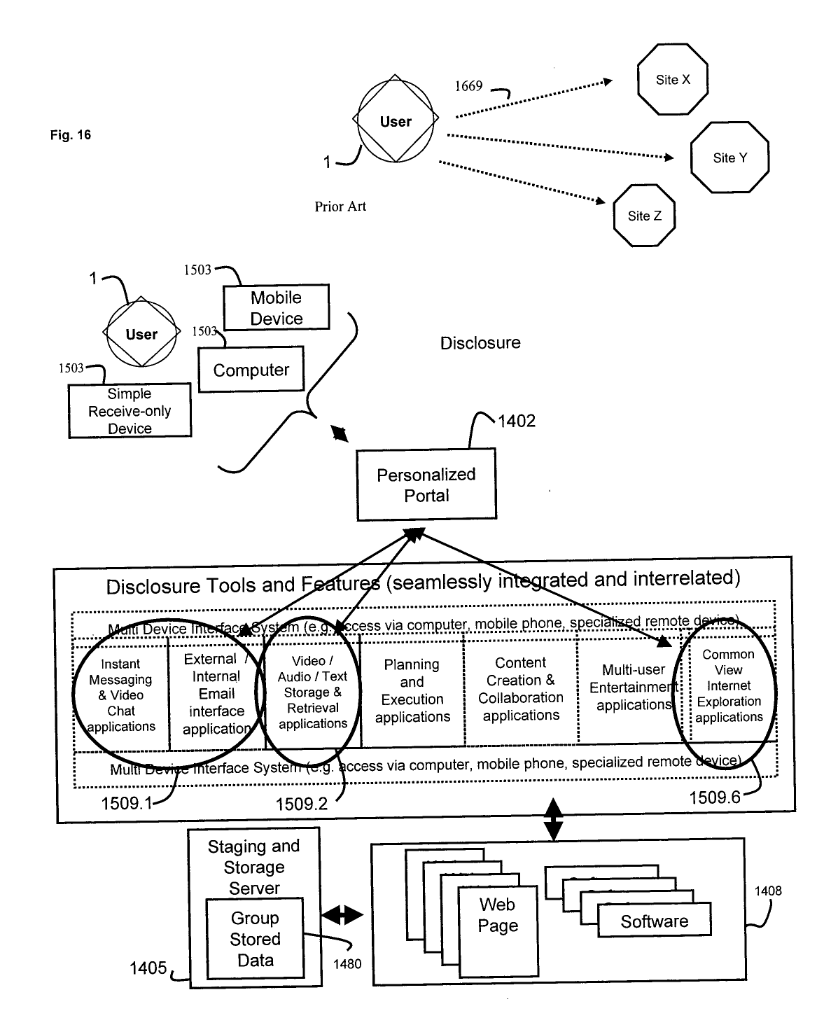

FIG. 16 identifies the disclosure and its key elements in relation to the prior art. Conventional systems impede efficiency and success due to the lack of comprehensive or integrated tools focused on group needs. Currently, a user 1 must try navigating a number of stand-alone, non-integrated tools located on disparate, unconnected sites 1669 which limits their applicability to accomplish collaborative work. Any data created by the user is typically saved within the user's own digital equipment.

Uniquely, the present disclosure allows a user 1 to accesses the integrated tools and features 1409 and by extension, the group's stored data 1480 via any of a number of electronic devices 1503, thus providing a synergy and collaborative contribution not currently available. The initial visual presentation to the user 1 is the personalized portal 1402 that allows immediate access to the specific web pages and software 1408 most useful for meeting the current focus of the group (i.e., collaboratively planning an out of town event or joining a scheduled card game). The tools and features 1409 are provided to user 1 individually or simultaneously to accomplish the desired task whether it is communicating with other members 1509.1, updating a task list or calendar 1509.2, or collaborating with other users online 1509.6. Data created, updated, or added can be stored in the group's data storage area 1480 for others to access.

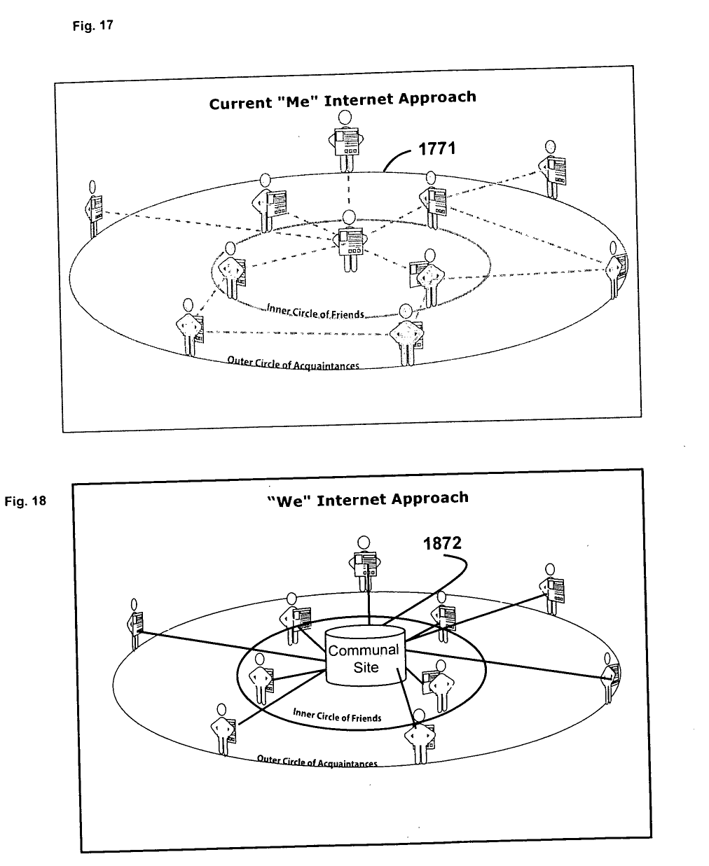

The present disclosure moves the focus away from the current “Me” approach as shown in FIG. 17 within the individual 1771 is at the center of the value chain towards a “We” approach shown in FIG. 18 where the focus is on group 1872. This change of focus by the present disclosure allows people to be a greater part of each others' lives. The present disclosure provides families, friends, and small organizations the ability to develop deeper, more meaningful and more productive bonds by offering them access to an exclusive, customized and centralized internet site, where they have simple and reliable tools to collaborate, share, and communicate. On their personalized group site, people do not simply exchange information, but collaboratively create and store new content. It allows families, friends and small organizations to create their own customized interaction where they can deepen their relationships by going far beyond just “staying-in-touch” and, instead, collaboratively creating shared experiences.

The present disclosure allows groups to focus on the unique needs and preferences of the group. On their site, groups can select which applications they want to use together. For example, a group can choose to have access to a shared photo album, centralized family recipes, and card games. The group can decide which applications make sense for them and have access to them in one convenient location. Groups create their own site, where they control access and always know who is online. This not only makes for a safer site, but also allows people to be much more genuine in their interactions. It also provides a secure and accessible location for the storage and sharing of the content created together.

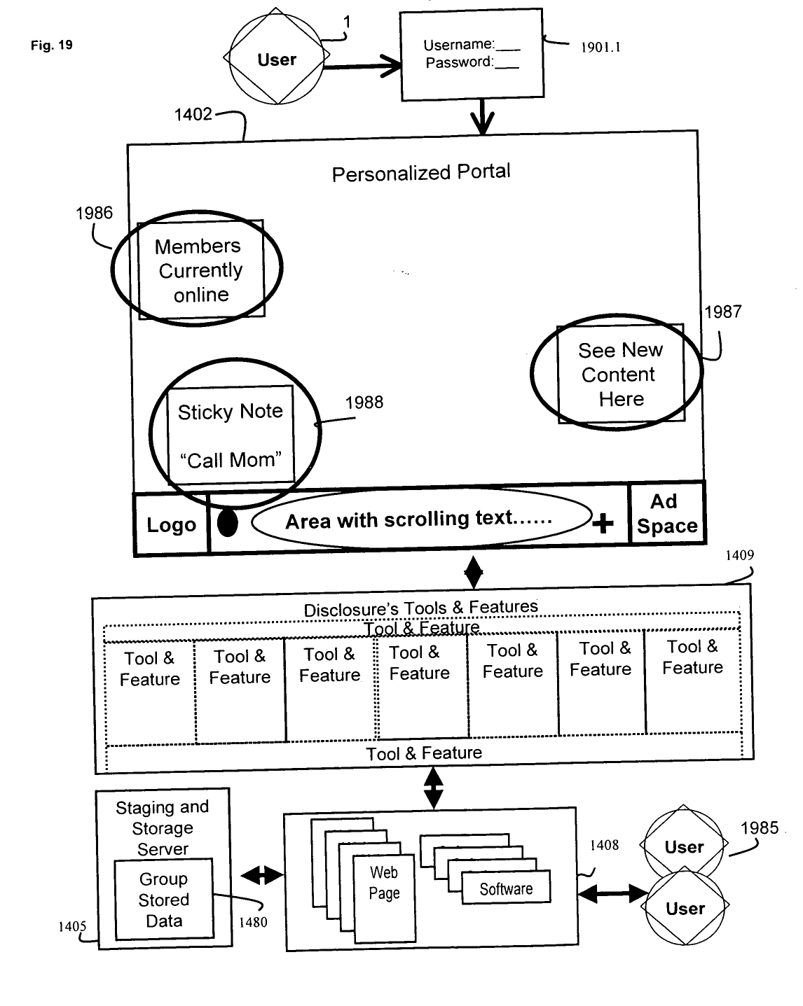

FIG. 19 is a sample personalized portal according to the present disclosure. Using a standard login/password protocol 1901.1, user 1 gains access to his personalized portal 1402. The personalized portal 1402 presents the underlying plurality of production server hosted web sites and software 1408 in a format that permits interaction with the members of the trusted and known network and that group's stored data 1480. The portal 1402 permits the actual connectivity and interaction with others. Utilizing the tools and features 1409 arranged in general categories, such as Communicate, Plan, Organize, Create, and Play Together, the user 1 accesses the group's stored data 1480 and resources, and/or interacts with other members currently online 1985. Dynamic tools and features such as a listing of members currently on the group site 1986, new content notifications 1987, and attention-grabbing “sticky notes” 1988 help the user 1 quickly gain situational awareness about group activities.

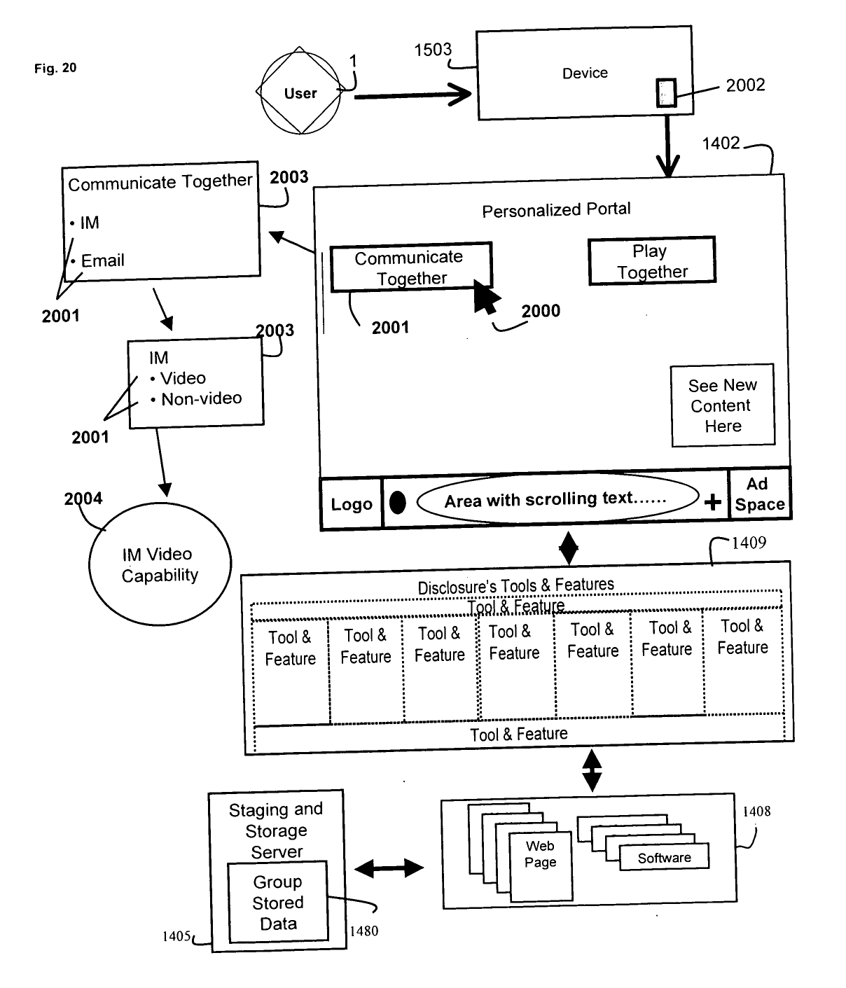

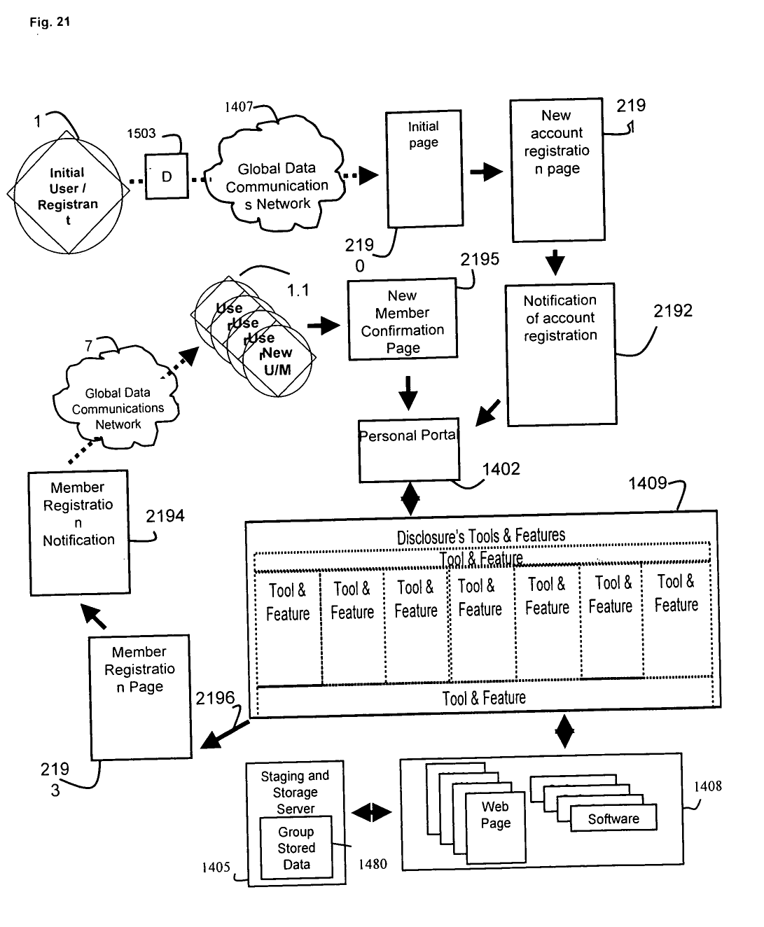

FIG. 20 describes the interaction between a user 1 and the personalized portal 1402 for the purpose of selecting and utilizing the tools and features 1409 of the disclosure. The user 1, having gained access to the personalized portal 1402, selects the offerings available within the tools and features 1409 by navigating a cursor 2000 or similar selection apparatus to a link 2001 on or within the portal 1402. Once the cursor 2000 is in contact with the link 2001, user 1 activates the link by pushing a button or key 2002 on their connection device 1503. Activating the link 2001 presents the user 1 with an interactive access window 2003 that provides the user 1 with more links 2001 to choices and options relative to the specific tool or feature 1409 desired. Each activation of a link 2001, further defines the specific tool and feature 1409 the user 1 is seeking and allows the user 1 to connect with and employ the plurality of web pages and software 1408 to deliver the capability or information the user 1 needs (i.e., selecting “Communicate Together” then presents the user with an option to select “Instant Messaging” (IM) or “Electronic Mail” (Email). Selection of IM, presents the user with an option to select “video” or “non-video”. Selecting “video” delivers the actual IM Video capability). Having selected the specific option or combination of options available through the links 2001, the user 1 is able to employ the tool desired 2004 in accordance with its attendant user and operating protocol. Multiple tools and features 1409 across the bonding categories can be opened and used simultaneously (i.e., the user 1 can open IM video, a planning template, and a calendar) by selecting those items through their attendant links. The supporting plurality of web pages and software 8 are the engines that power the capabilities of the tools and features 1409 selected.

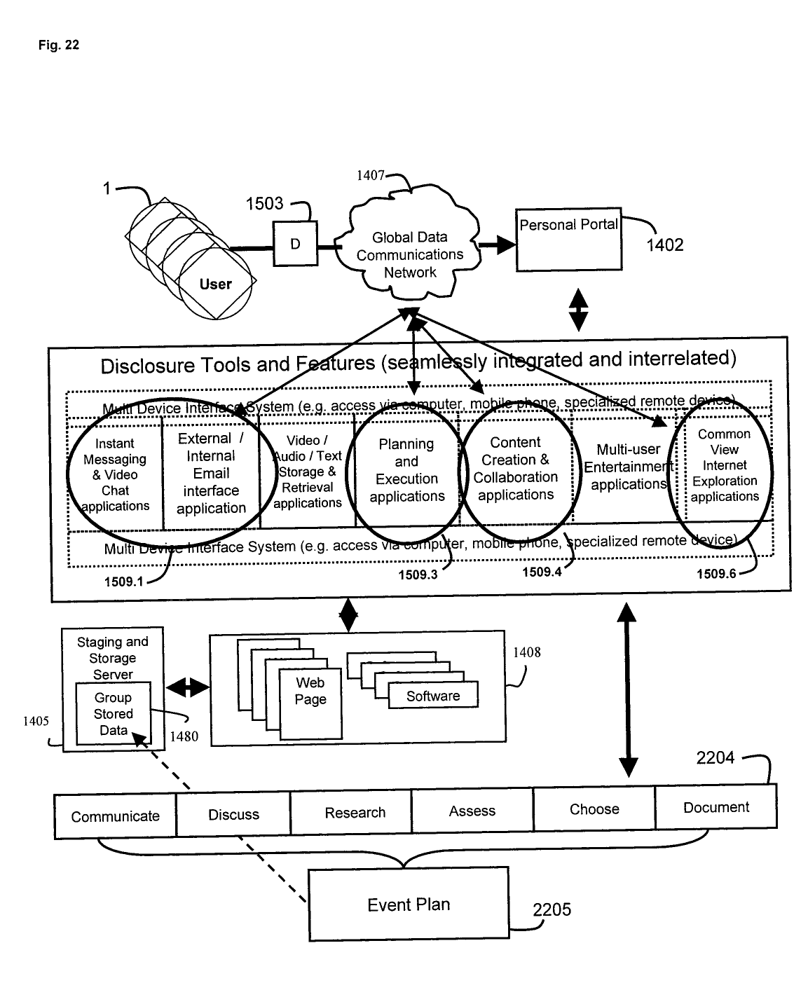

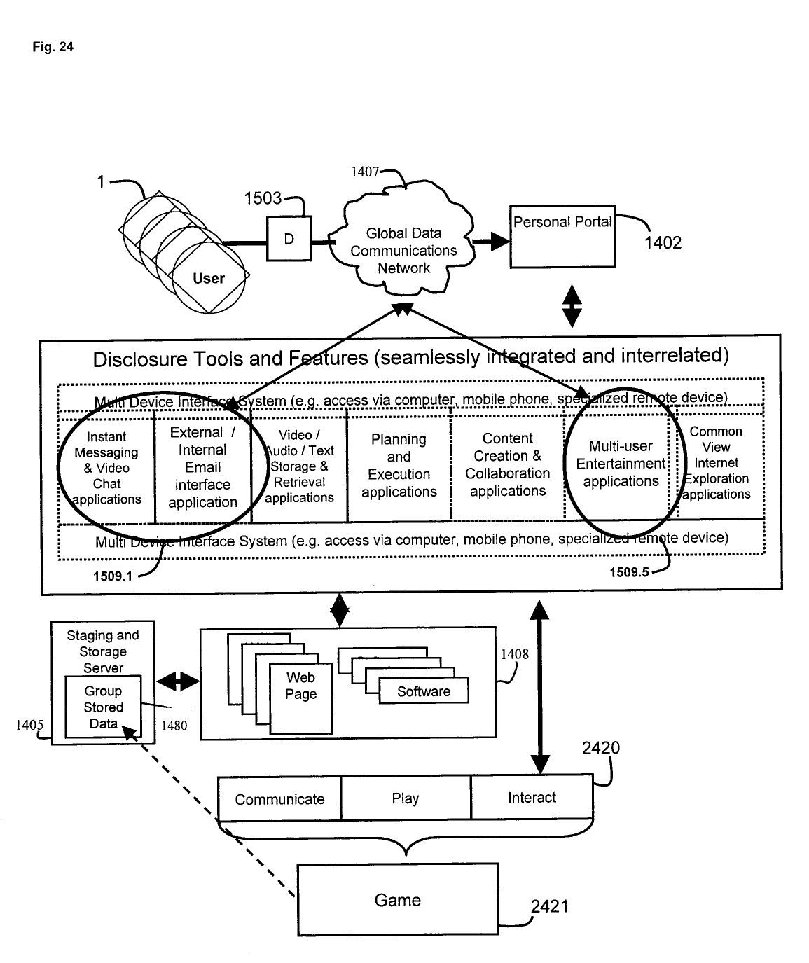

As further described in FIGS. 22 and 24 below, the portal 1402 allows the user 1 to select and employ the tools and features 1409 necessary to accomplish both group and personal tasks. The end result is an interaction with the group that helps strengthen connections and bonds.

FIG. 21 is a schematic depicting the initial set-up of a group's site and the population of shareable content. A user/registrant 1 utilizes an electronic device 1503 and a global data communication network 1407 to connect to the disclosure's production server hosted initial page 2190. The user navigates to a new account registration page 2191, and, upon satisfactory completion, the group is created and an account notification is provided 2192. With an account notification 2192, the user/registrant 1 is able to access his personal portal 1402. Employing the portal 1402, the user/registrant 1 can use the tools and features 1409 and the connected plurality of web pages and software 1408 to set up the group's data storage area 1480 and register additional group members via a member registration page 2193. When a new user/member is added to the group via the member registration page 2193, a notification of registration 2194 is sent via the global data communication network 1407 to the new user/member 1.1 directing them to a new member confirmation page 2195. The new user/member 1.1 successfully completes the confirmation process and is presented with a personal portal 1402. With a personal portal 1402, a new user/member 1.1 can access the tools and features 1409 and the group's data storage 1480. The assignment of membership for the group 2196, and by extension, the ability to create a personalized portal 2 and participate in the group's site and activities is vested in the initial user/registrant 1. Once joined as a member of the group, any user 1-1.1 can access, add, alter group content stored in the group's data storage area 1480 or participate in group activities through their personalized portal 1402 within the limits specified by the initial group registrant 1. For example, all adult members of a group may be granted unlimited capabilities, while minors might be limited in their access to group data or communicative features.

The present disclosure allows group members to participate in a collaborative and meaningful way in the activities traditionally accomplished by established networks, namely planning, creating, sharing, and playing. Utilizing the disclosure's tools, members can work together to accomplish such tasks as planning vacations, weddings, graduations, picnics and parties. The creating tools allow members to publish together, make cards, develop a multi-media family timeline, write newsletters, and mix audio and video files. Sharing tools allow members to store family recipes, set up and access a comprehensive address book create group calendars, and even catalogue favorite jokes. Playing tools allow members to hold card nights, enjoy board games, and solve puzzles. Members can also shop and surf together creating shopping and gift lists and collectively exploring the net for sites that help them accomplish group tasks. Specific examples of the steps and tasks related to these capabilities and activities are presented below.

FIG. 22 describes how users 1 within a group can accomplish a collaborative planning and organizing task. After logging in via a device 1503 connected to a global data communication network 1407, the users 1 employ their portals 1402 to access the tools and features 1509 that will help them efficiently handle a planning task. Opening communication tools 1509.1 such as IM/Video Chat, Planning tools 1509.3 such as Planning Templates, creation tools 1509.4 such as Shared Calendar, and Notes Pages, and other assets such as and Online Search 1509.6, the users 1 communicate in near real time as they perform the planning process of discussing, researching, assessing, choosing, and documenting 2204 necessary to create an event plan 2205. The tools and features 1409 allow access to the specific web pages and applications 1408 to both accomplish their tasks and to retrieve, use, and store the group's data in the group data storage section 1480 of the staging and storage server 1405. The ability of the entire group to have the range of task-critical tools presented delivers an efficient and collaborative experience that helps deepen their bonds.

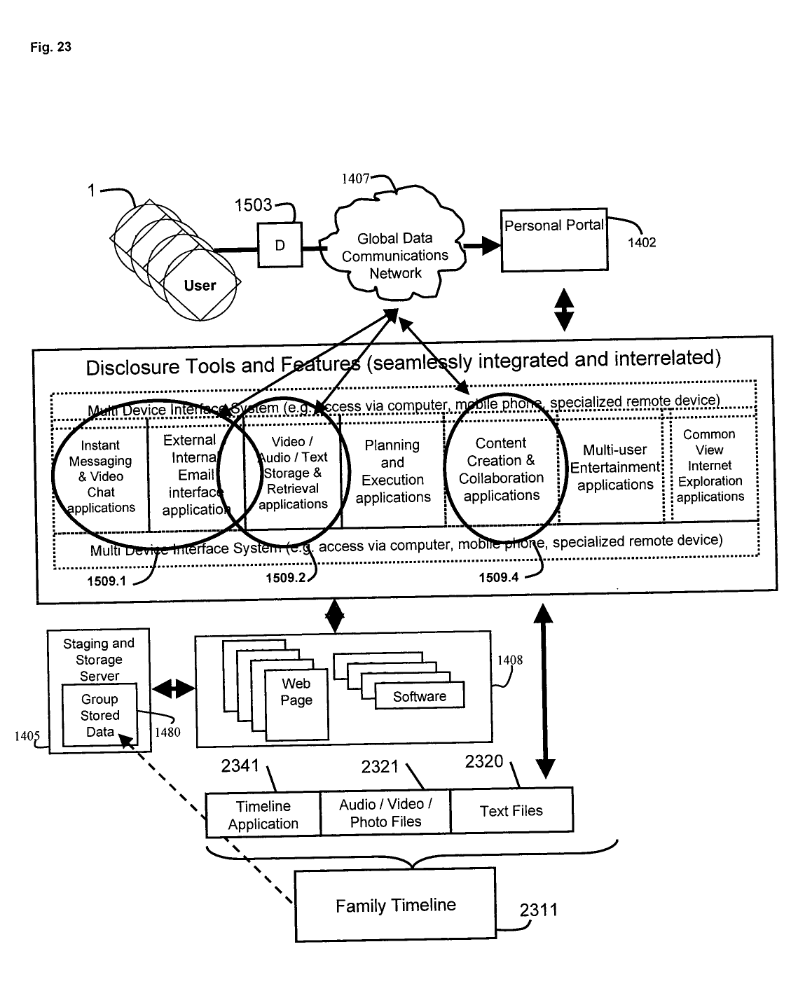

FIG. 23 describes how users 1 within a group can collaboratively create and store shared content for the group. After logging in via a device 1503 connected to a global data communication network 1407, users 1 employ their portals 1402 to access the tools and features 1409 that will help them efficiently handle a creating task. The tools and features 1409 allow the group to retrieve, use, and, when done, store the group's data in the group data storage section 1480 of the staging and storage server 1405. In this case, users 1 open the communication tools 1509.1, data upload and retrieval tools 1509.2, and content creation tools 1509.4 that allow the group to develop a multi-media family timeline 2311. Key dates are discussed via the communication tools 1509.1 and entered into a timeline application 2341. Related photo/audio/video files are uploaded and attached to timeline 2321. Text, created as the group reminisces in near real time, is recorded via a Notes tool and appended to the timeline 2342. The collaborative efforts and experience of sharing in the creation of the timeline help deepen the bonds of the participants.

FIG. 24 describes how users within a group can hold a multi-participant online game. After logging in via a device 1503 connected to a global data communication network 1407, users 1 employ their portals 1402 to access the tools and features 1409 that will help them efficiently handle a game task. The tools and features 1409 allow the group to retrieve, use, and store the group's data in the group data storage section 1480 of the staging and storage server 1405. Opening communication tools 1509.1 and game tools 1509.5, the group participates in any number of types of games or play activities (e.g., card games, board games, puzzles) that are available through the tools and features 1409. Near real time communication via the communication tools 1509.1 combined with the gaming activity provided by the game tools 1509.5, allows the participants to communicate, game, and interact 2420 as they compete in the game 2421. The experience of playing within a known and trusted environment helps deepen the bonds of the participants.

As the figures and descriptions have outlined, with the disclosure, members of a group can interact and communicate in ways that are not currently available to them. Members can generate inherently relevant content for the enjoyment and use of an established, trusted, and exclusive group the only people who upload messages to a group's ticker are members who have been invited to participate in the group. This makes the material safer and more pertinent. The ability to dynamically manage members-current users can invite new members of the group to participate in the ticker—allows the ticker to grow as the group grows but via a means that helps ensure exclusivity and trust. The ability to view the content of multiple groups on one ticker means users can be retain their relationships with any number of groups, while at the same time deepening their bonds with those they care for and about. Participation in the ticker communication via multiple forms of current technology—users upload and receive messages from any number of communication devices, such as desktop computers, laptop computers, hand-held PDA-type devices, cellular phones and other communications vehicles—means members can stay connected without regard to geographic location or type or sophistication of their communication device. This greatly expands the ability and nature of the group's communication and interaction. The result is a deepening of the bonds that connect them.

The present disclosure provides families, friends, and small organizations with the ability to develop deeper, more meaningful and more productive bonds by offering them access to an exclusive, customized and centralized Internet site, where they will have simple and reliable tools to collaborate, organize, share, and communicate. On their personalized group site, according to the present disclosure, people do not simply exchange information, but collaboratively create and store new content. The present disclosure allows families, friends and small organizations to create their own customized Internet site, where they can deepen their relationships by going far beyond just “staying-in-touch” and, instead, collaboratively creating shared experiences.

The present disclosure focuses on the unique needs and preferences of the group. Through the present disclosure, groups can select which applications they want to use together. For example, a group can choose to have access to a shared photo album, centralized family recipes, and card games. The group can decide which applications make sense for them and have access to them in one convenient location.

The present disclosure also offers exclusivity. Groups create their own sites, where they control access and always know who is online. This not only makes for a safer site, but also allows people to be much more relaxed and honest in their interactions. The present disclosure also delivers a secure location for the content people create together.

The term “module” is used herein to denote a functional operation that may be embodied either as a stand-alone component or as an integrated configuration of a plurality of sub-ordinate components.

Steps associated with these processes can be performed in any order, unless otherwise specified or dictated by the steps themselves.

Although system 3000 is described herein as having the instructions for the method(s) of the present invention installed into memory 3200, the instructions can be tangibly embodied on an external computer-readable storage medium 3400 for subsequent loading into memory 3200. Storage medium 3400 can be any conventional storage medium, including, but not limited to, a floppy disk, a compact disk, a magnetic tape, a read only memory, or an optical storage media. The instructions could also be embodied in a random access memory, or other type of electronic storage, located on a remote storage system and coupled to memory 3200.

Moreover, although the instructions, are described herein as being installed in memory 3200, and therefore being implemented in software, they could be implemented in any of hardware, firmware, software, or a combination thereof.

The techniques described herein are exemplary, and should not be construed as implying any particular limitation on the present invention. It should be understood that various alternatives, combinations and modifications could be devised by those skilled in the art. The present invention is intended to embrace all such alternatives, modifications and variances that fall within the scope of the appended claims.

What is claimed is:

1. A method comprising the steps of:
granting, to a first client, access to a data structure;
granting, to a second client, access to said data structure;
transmitting, if said first client has caused a write operation on said data structure, a communication to said second client; and
transmitting, if said second client has caused a write operation on said data structure, a communication to said first client.

2. A method comprising the steps of:
granting, to a first client, read-write access to a first data structure;
granting, to a second client, read access to said first data structure;
granting, to said second client, read-write access to a second data structure;
granting, to said first client, read access to said second data structure;
transmitting, if said first client has caused a write operation on said first data structure, a communication to said second client; and
transmitting, if said second client has caused a write operation on said second data structure, a communication to said first client.

3. The method of claim 2, further comprising the steps of:
granting, to a third client, read access to said first and said second data structures;
transmitting, if said first client has caused a write operation on said first data structure, a communication to said third client; and
transmitting, if said second client has caused a write operation on said second data structure, a communication to said third client.

4. A system comprising:
a first client device;
a processor;
a memory;
wherein:
said processor is in communication with said memory;
said first client has a user interface that is a ticker;
said first client device is in communication with said processor via a communication network;
said processor instantiates a data store in said memory comprising a first data structure and a second data structure;

5. The system of claim 4 wherein said ticker:
is customizable to a preference of a user thereof;
presents to said user data that are resident in said data store;
presents data to said user according to characteristics of said data;

6. The system of claim 4 wherein said ticker further comprises:
a portal to a software module that permits a user of said client device to interact with data resident in said data store.

7. The system of claim 6 wherein said portal:
permits said user to interact with data resident in a data store that is a second data store.

8. The system of claim 4 wherein:
said first client device is at least one communication device selected from the group consisting of: a PDA, a general-purpose computer; a special-purpose computer, and a mobile communication device.

9. The system of claim 4, further comprising:
a second client device that is in communication with said processor.

10. The system of claim 4, further comprising:
a module resident in said memory, wherein:
said module, when executed by said processor, provides an access on said data store to said first client.

11. A method for strengthening group bonds, comprising the steps of:
instantiating a data store that is dedicated to a predetermined group of users;
receiving, into said data store, data generated by a first member of said group;
providing an access to said data to a second member of said group; and
presenting said data to said second member of said group.

12. The method of claim 11 wherein:
said step of presenting is modified according to a characteristic of said second member selected from the group consisting of: user skill, user identity, and user age.

13. The method of claim 11 further comprising the step of:
receiving, from said second member, a communication into said data store;
wherein said communication is transmitted from said data store to said first member.

14. A storage medium having an instruction encoded thereon in machine-readable format, wherein said instruction, when executed by a processor, causes said processor to carry out a method having the steps of:
granting, to a first client, read-write access to a first data structure;
granting, to a second client, read access to said first data structure;
granting, to said second client, read-write access to a second data structure;
granting, to said first client, read access to said second data structure;
transmitting a communication to said second client, when said first client has caused a write operation on said first data structure;
transmitting a communication to said first client, when said second client has caused a write operation on said second data structure.
